(19) United States
(12) Patent Application Publication
(10) Pub. No.: US 2009/0048898 A1
(43) Pub. Date: Feb. 19, 2009

(54) Method of Managing Schedule and Server and Program for Performing the Same

(76) Inventor: Toshiyuki Omiya, Tokyo (JP)

Correspondence Address: Nixon Peabody LLP, 200 Page Mill Road, Palo Alto, CA, 94306, US

(21) Appl. No.: 12/093,449

(22) PCT Filed: Nov. 8, 2006
(86) PCT No.: PCT/JP2006/322297

§ 371 Date: May 12, 2008

(30) Foreign Application Priority Data
Nov. 14, 2005 (JP) 2005-329424

(51) Int. Cl. G06Q 10/00

(52) U.S. Cl. 705/9

(57) ABSTRACT

A schedule management server is provided with a transmitting means for transmitting information of the number of necessary staffs estimated in advance to terminal devices for transmitting desirable working schedules. A computer (1) comprises a communication network (3) and a terminal device (4). The computer (1) generates assumed schedule data indicative of schedules assumed for a plurality of staffs and starts receiving desired schedule data indicative of schedules desired by the plurality of staffs from the terminal device (4) connected to the communication network (3). The computer (1) sends the assumed schedule data to the terminal device (4) at the request of the terminal device (4) connected to the communication network (3). The computer (1) receives and stores the desired schedule data indicative of staffs' desired schedules from the terminal device (4) and generates temporarily determined schedules for the staffs based on the assumed schedule data and the desired schedule data.

### CROSS REFERENCE TO RELATED APPLICATIONS

This application is a U.S. national phase application based on International Application No. PCT/JP2006/322297 entitled, “Method of Managing Schedule and Server and Program for Performing the Same,” filed on Nov. 8, 2006, which was not published in English, which is based on and claims the benefit of priority under 35 U.S.C. §119 from Japanese Patent Application No. 2005-329424, filed on Nov. 14, 2005.

### TECHNICAL FIELD

The present invention relates to a method of managing a schedule, and a server and a program for performing the method. In particular, the present invention relates to a method of managing a work schedule, and a server and a program for performing the method.

### BACKGROUND ART

A variety of methods of managing the work schedules of employees have conventionally been proposed. For example, Japanese Unexamined Patent Application Publication No. 2003-167981 discloses a schedule management system that collects via a network preferred schedule data of call center operators, and generates schedule data for a predetermined period of time, based on the preferred schedule data thus collected.

The schedule management system determines the schedules by accepting via the network the preferred schedule data from the individual operators, predicting a number of operators needed in the predetermined period of time, and comparing both data.

In accordance with the above system, each operator, by sending that operator's preferred schedule over the network, in a case when that preferred schedule sufficiently matches the predicted number of operators, can obtain a work schedule that reflects that preferred schedule.

### DISCLOSURE OF THE INVENTION

### Problems to be Solved by the Invention

However, in the above-mentioned system, the individual operators cannot learn the predicted necessary number of operators when they input their preferred schedules. Therefore, for example, when the predicted necessary number of operators differs depending on day and time zone, such as peak times or an unbusy day, even if a certain operator whose work schedule is adjustable to the difference is available, it is actually difficult to take into account an appropriate adjustment.

Further, at any time if after preferred schedules are inputted, an excess or deficiency of the number of persons differs depending on day and time zone, for the same reason, it is difficult for the operators to recognize a difference of an excess or deficiency of the number of persons, and consider adjustment to the preferred schedules to be inputted.

In the absence of consideration of the adjustment as described above, it is probable that the results of inputs of the operators' preferred schedules do not match the predicted necessary number of operators. In this case, the schedule manager is required to make readjustment of the schedules.

### Means for Solving the Problems

The present invention aims at overcoming the above-mentioned problems by providing a schedule management server having means for transmitting in advance information of a predicted necessary number of persons, to terminals through which preferred work schedules are transmitted, respectively.

(1) A method of managing work schedules of a plurality of staff members by a computer (for example, a server 1 and a manager terminal 2 described later, and the like) connected to a communication network (for example, an internal communication network 3 and an external communication network 5 described later, and the like). The method includes the following steps of: an assumed schedule data generation step (for example, an assumed schedule data generation processing step S100 described later) in which the computer generates assumed schedule data indicating assumed schedules of the plurality of staff members (for example, an assumed schedule data table described later and the like); a preferred schedule data acceptance starting step (for example, step S201 and step S203 described later, and the like) in which the computer specifies a predetermined period of time and starts to accept preferred schedule data indicating preferred schedules of the plurality of staff members (for example, a preferred schedule data table described later and the like) from terminals connected to the communication network (for example, operator terminals 4 and operator-portable terminals 6a and 6b described later, and the like); an assumed schedule data transmission step (for example, step S209 described later and the like) in which the computer transmits the generated assumed schedule data to the terminals connected to the communication network in response to requests from the terminals, respectively; a preferred schedule data receiving step (for example, step S219 described later and the like) in which the computer receives from the terminals the preferred schedule data indicating preferred schedules of the plurality of staff members, respectively, and stores the preferred schedule data; and a presumptive schedule data generation step (for example, step S300 described later and the like) in which, after an elapse of the specified predetermined period of time, the computer generates presumptive schedule data indicating presumptive schedules of the plurality of staff members, based on the assumed schedule data and the preferred schedule data (for example, a presumptive schedule data table described later and the like).

In the invention of the above (1), the computer generates the assumed schedule data indicating the assumed schedules of a plurality of staff members, specifies the predetermined period of time and starts to accept the preferred schedule data indicating the preferred schedules of these staff members from the terminals connected to the communication network, transmits the generated assumed schedule data to the terminals connected to the communication network in response to the requests from the terminals, respectively, receives from the terminals the preferred schedule data indicating the preferred schedules of these staff members, respectively, and stores these data, and after the elapse of the specified predetermined period of time, generates the presumptive schedule data indicating the presumptive schedules of these staff members, based on the assumed schedule data and the preferred schedule data.

This enables the terminals to display in advance the assumed schedule to a plurality of staff members who are going to input preferred schedule data to the terminals, respectively. As a result, the plurality of staff members after viewing the assumed schedule can take into consideration their own preferred schedules and input preferred schedule data by referring to the assumed schedule.

(2) The method as set forth in the above (1), in which the computer transmits the stored preferred schedule data to the terminals (for example, step S209 described later and the like) in response to requests from the terminals, respectively, (for example, step S205 described later and the like) in the assumed schedule data transmission step.

In the invention of the above (2), the computer transmits the stored preferred schedule data to the terminals in response to the requests from the terminals, respectively.

This enables the terminals additionally to display the preferred schedules being stored in the computer at the time when the plurality of staff members input their respective preferred schedule data during a predetermined period of time. Hence, individual staff members can take into consideration their respective preferred schedules by referring to other staff members' preferred schedules in addition to an assumed schedule.

(3) The method as set forth in the above (1) or (2), in which the computer further generates peak data indicating peak information related to the assumed schedule (for example, weekly holiday data described later and the like) in the assumed schedule data generation step (for example, step S113 described later and the like), and the computer additionally transmits the generated peak data to the terminals in the assumed schedule data transmission step (for example, step S209 described later and the like).

In the invention of the above (3), the computer further generates peak data indicating peak information related to the assumed schedule, and additionally transmits the generated peak data to the terminals.

This enables the terminals additionally to display peak information related to the assumed schedule when the plurality of staff members input their respective preferred schedule data in the predetermined period of time. Hence, individual staff members can take into consideration their respective preferred schedules by referring to the peak information in addition to an assumed schedule.

(4) The method as set forth in any one of the above (1) to (3), in which the computer additionally receives priority data indicating the priority of the preferred schedule in the preferred schedule data receiving step (for example, step S219 described later and the like), and the computer generates presumptive schedule data (for example, a presumptive schedule data table described later and the like) based on the assumed schedule data, the preferred schedule data and the priority data in the presumptive schedule data generation step (for example, step S309 described later and the like).

In the invention of the above (4), the computer additionally receives the priority data indicating a priority of the preferred schedules, and generates presumptive schedule data based on the assumed schedule data, the preferred schedule data and the priority data.

This enables a presumptive schedule to be determined based on a priority of the preferred schedules inputted by the staff members. Therefore, preferred schedules of individual staff members can be reflected in the presumptive schedule, based on more flexible considerations.

(5) The method as set forth in any one of the above (1) to (4), in which the computer receives the preferred schedule data a predetermined number of times from individual staff members' terminals, respectively, in the preferred schedule data receiving step (for example, step S219 described later and the like).

In the invention of the above (5), the computer receives the preferred schedule data a predetermined number of times from individual staff members' terminals, respectively.

This prevents a specific staff member from transmitting a greater amount of preferred schedule data than other staff members, thus enabling more staff members' preferred schedules to be reflected in presumptive schedule data.

(6) The method as set forth in any one of the above (1) to (5), in which the computer generates the presumptive schedule data limited to a range where the number of the plurality of staff members does not exceed a prespecified maximum number (for example, an upper limit line 189 in FIG. 18) in the presumptive schedule data generation step.

In the invention of the above (6), the computer generates presumptive schedule data limited to a range where a number of staff members does not exceed a pre-specified maximum number.

This prevents any setting of schedules exceeding the maximum number of schedulable staff members.

(7) The method as set forth in any one of the above (1) to (6), in which the computer generates the presumptive schedule data based on processing efficiency data of the plurality of staff members with respect to a predetermined task (for example, a processing efficiency 186 in FIG. 18) in the presumptive schedule data generation step.

In the invention of the above (7), the presumptive schedule data can be generated based on the processing efficiency data of the staff members with respect to a predetermined task.

This enables the generation of a schedule satisfying the required task quantity even when including a plurality of staff members having different processing efficiencies. For example, such cases as the following can be handled: When a certain task requires one staff member having a processing efficiency of 100%, and there are only staff members having a processing efficiency of 50%, the required task quantity can be satisfied by scheduling two staff members having a processing efficiency of 50%.

(8) The method as set forth in any one of the above (1) to (7), in which the computer generates a plurality of overlapped presumptive schedules of a predetermined staff member among the plurality of staff members, in the presumptive schedule data generation step.

In the invention of the above (8), a plurality of overlapped presumptive schedule data can be generated for a predetermined staff member.

This enables a plurality of tasks to be concurrently assigned to a certain staff member who can handle a plurality of tasks simultaneously. More specifically, for example, a task having low urgency can be handled in a vacant time, thus achieving a more efficient schedule setting.

(9) A program causing a computer (for example, a server 1 and a manager terminal 2 described later, and the like) connected to a communication network (for example, the internal communication network 3 and the external communication network 5 described later and the like) to manage work schedules of a plurality of staff members, wherein the program causes the computer to perform the following steps of: an assumed schedule data generation step (for example, an assumed schedule data generation processing step S100 described later) causing the computer to generate assumed schedule data indicating assumed schedules of the plurality of staff members (for example, an assumed schedule data table, described later, and the like); a preferred schedule data acceptance starting step (for example, step S201, step S203, described later, and the like) causing the computer to specify a predetermined period of time and start to accept preferred schedule data indicating preferred schedules of the plurality of staff members (for example, a preferred schedule data table, described later, and the like) from terminals connected to the communication network (for example, the operator terminals 4 and the operator-portable terminals 6a and 6b described later and the like); an assumed schedule data transmission step (for example, step S209 described later and the like) causing the computer to transmit the generated assumed schedule data to terminals connected to the communication network in response to requests from the terminals, respectively; a preferred schedule data receiving step (for example, step S219 described later and the like) causing the computer to receive from the terminals the preferred schedule data indicating preferred schedules of the plurality of staff members, respectively, and to store the preferred schedule data; and a presumptive schedule data generation step (for example, step S300 described later and the like) causing, after an elapse of the specified predetermined period of time, the computer to generate presumptive schedule data indicating presumptive schedules of the plurality of staff members based on the assumed schedule data and the preferred schedule data (for example, a presumptive schedule data table described later and the like).

In the invention of the above (9), the same effect as the above (1) can be expected by operating the computer.

(10) The program as set forth in the above (9), causing the computer to transmit the stored preferred schedule data additionally to the terminals (for example, step S209 described later and the like) in response to requests from the terminals, respectively, (for example, step S205 described later and the like) in the assumed schedule data transmission step.

In the invention of the above (10), the same effect as the above (2) can be expected by operating the computer.

(11) The program as set forth in the above (9) or (10), causing the computer further to generate peak data indicating peak information related to the assumed schedule (for example, a day unavailable for a weekly holiday, described later, and the like) (for example, step S113 described later and the like) in the assumed schedule data generation step, and causing the computer additionally to transmit the generated peak data to the terminals (for example, step S209 described later and the like) in the assumed schedule data transmission step.

In the invention of the above (11), the same effect as the above (3) can be expected by operating the computer.

(12) The program as set forth in any one of the above (9) to (11), causing the computer to additionally receive priority data indicating the priority of the preferred schedule (for example, step S219 described later and the like) in the preferred schedule data receiving step, and causing the computer to generate presumptive schedule data (for example, a presumptive schedule data table described later, and the like) based on the assumed schedule data, the preferred schedule data, and the priority data (for example, step S309 described later and the like) in the presumptive schedule data generation step.

In the invention of the above (12), the same effect as the above (4) can be expected by operating the computer.

(13) The program as set forth in any one of the above (9) to (12), causing the computer to receive the preferred schedule data a predetermined number of times from the individual staff members' terminals, respectively, (for example, step S219 described later and the like) in the preferred schedule data receiving step.

In the invention of the above (13), the same effect as the above (5) can be expected by operating the computer.

(14) The program as set forth in any one of the above (9) to (13), causing the computer to generate the presumptive schedule data limited to a range where the number of the plurality of staff members does not exceed a prespecified maximum number, in the presumptive schedule data generations step.

In the invention of the above (14), the same effect as the above (6) can be expected by operating the computer.

(15) The program as set forth in any one of the above (9) to (14), causing the computer to generate the presumptive schedule data based on processing efficiency data of the plurality of staff members with respect to a predetermined task, in the presumptive schedule data generation step.

In the invention of the above (15), the same effect as the above (7) can be expected by operating the computer.

(16) The program as set forth in any one of the above (9) to (15), causing the computer to generate a plurality of overlapped presumptive schedules of a predetermined staff member among the plurality of staff members, in the presumptive schedule data generation step.

In the invention of the above (16), the same effect as the above (8) can be expected by operating the computer.

(17) A storage medium storing the program as set forth in any one of the above (9) to (16).

In the invention of the above (17), the same effects as the above (1) to (8) can be expected by inserting the storage medium into the computer so as to perform the program.

### EFFECTS OF THE INVENTION

In accordance with the present invention, with respect to a plurality of staff members inputting their respective preferred schedule data into terminals, the terminals are capable of displaying the assumed schedule in advance. Thus, the plurality of staff members who have viewed the assumed schedule can take into consideration their respective preferred schedules and input preferred schedule data by referring to the assumed schedule.

As a result, individual staff members can think about their preferred schedules that they input by referring to the assumed schedule at the time of the input thereof, while expecting their own desire will be reflected in the presumptive schedule. It is thus possible to naturally generate a cooperative labor-management relationship in work schedule management.

### BRIEF DESCRIPTION OF THE DRAWINGS

FIG. 1 is a conceptual diagram showing an overall configuration of a computer system according to an example of an embodiment of the present invention;

FIG. 2 is a block diagram showing a configuration of the computer system in an example of an embodiment;

FIG. 3 is a chart showing the main flow in an example of an embodiment;

FIG. 4 is a diagram showing a flow of assumed schedule data generation processing in an example of an embodiment;

FIG. 5 is a display example of call quantity statistical data in an example of an embodiment;

FIG. 6 is a display example of a predicted call quantity in an example of an embodiment;

FIG. 7 is a display example of a screen indicating an assumed necessary number of operators per unit time in an example of an embodiment;

FIG. 8 is a diagram showing a weekly holiday data table in an example of an embodiment;

FIG. 9 is a display example of a setting for unavailable day for weekly holiday in an example of an embodiment;

FIG. 10 is a display example of a number of operators who can take a weekly holiday in an example of an embodiment;

FIG. 11 is a diagram showing an assumed schedule data table in an example of an embodiment;

FIG. 12 is a display example of a screen indicating an assumed necessary number of operators per unit time and work type in an example of an embodiment;

FIG. 13 is a flow chart showing preferred schedule data generation processing in an example of an embodiment;

FIG. 14 is a display example of an input screen of the application for weekly holidays in an example of an embodiment;

FIG. 15 is a diagram showing a preferred schedule data table in an example of an embodiment;

FIG. 16 is a flow chart showing presumptive schedule data generation processing in an example of an embodiment;

FIG. 17 is a display example of an input screen for granting the application for a weekly holiday in an example of an embodiment;

FIG. 18 is a display example of a presumptive schedule generation screen in an example of an embodiment;

FIG. 19 is a diagram showing a presumptive schedule data table in an example of an embodiment; and

FIG. 20 is a display example of a tentative decision notification screen in an example of an embodiment.

### PREFERRED MODE FOR CARRYING OUT THE INVENTION

A preferred embodiment of the present invention will be described below with reference to the accompanying drawings.

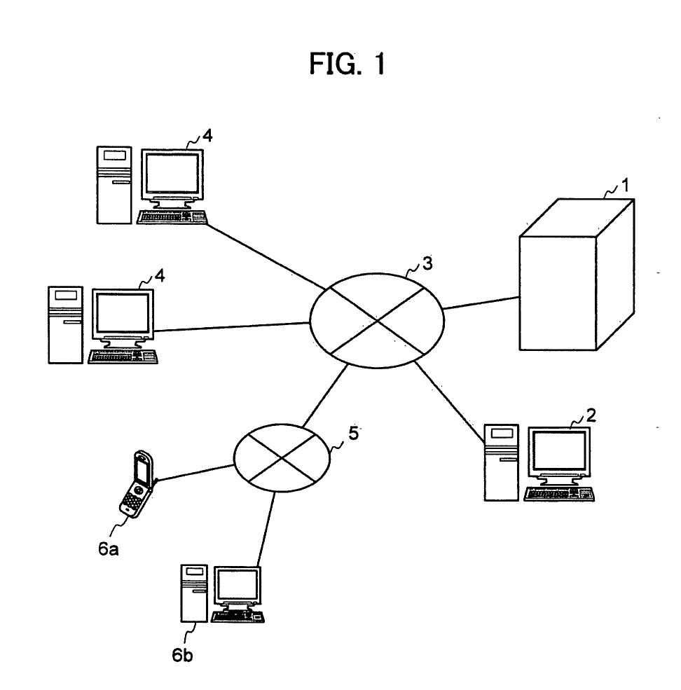

FIG. 1 is a conceptual diagram showing an overall configuration of a computer system according to a preferred embodiment of the present invention. In this system, a server 1, a manager terminal 2, and operator terminals 4 are connected to one another through an internal communication network 3. Alternatively, these information devices may be further connectable through an external communication network 5 to operator-portable terminals 6a and 6b. Here, the quantities of a server 1, a manager terminal 2, operator terminals 4 and operator-portable terminals 6a and 6b, each configuring the system, are arbitrary and selectable depending on a situation.

The server 1 carries out overall management of the system, and transmits data to the operator terminals 4 and the like. Also, the server 1 stores statistical data such as the past call quantity and the like, personal information such as operators' skills and their contacts, evaluation information, schedule data, and the like, and carries out various processes such as schedule data generation, in accordance with requests from the manager terminal 2, the operator terminals 4, and the like.

Here, the term “schedule” means information used for operator assignment and weekly holiday management in a predetermined unit of work. In addition, schedule data is data storing a schedule. Examples of the schedule data include assumed schedule data to be generated by calculating a call quantity estimated from past call quantity, and then determining an assumed number of operators based on the estimated call quantity; and presumptive schedule data to be generated by actually assigning and collecting operators based on the assumed schedule.

Based on a manager's input operation, the manager terminal 2 transmits to the server 1a request to generate a schedule, and performs operator assignment and weekly holiday management in accordance with the schedule. The manager terminal 2 also accesses the server 1 at any time to set a schedule and request generating recruitments for operators and responses to applications.

The operator terminals 4 are for performing, based on an operator's input operation, applications for weekly holidays, applications for operator recruitment, and the responses to employment applications or the like, with respect to the schedules laid open to the public by the server 1.

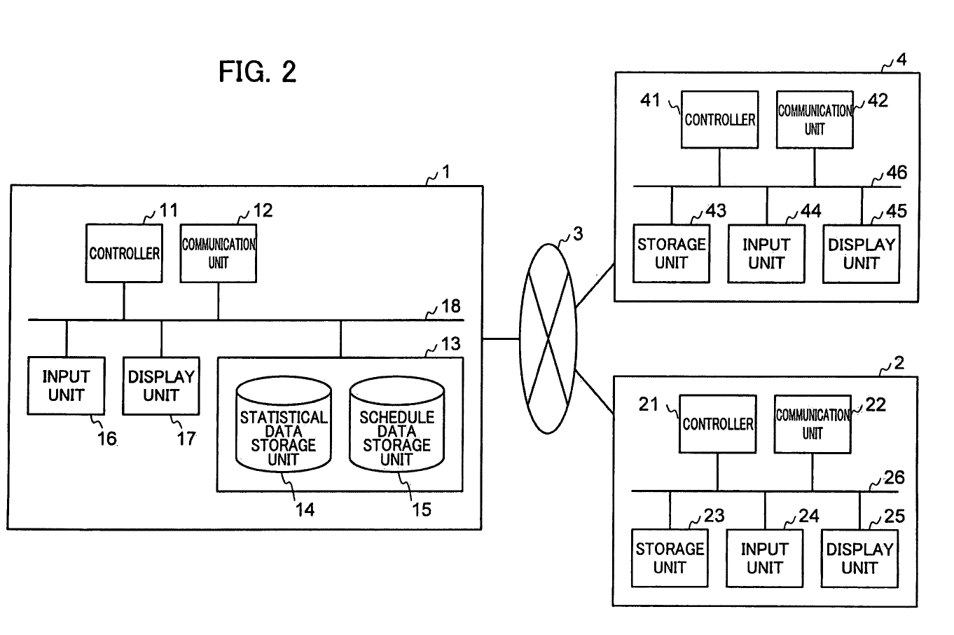

FIG. 2 is a block diagram showing configurations of the server 1, the manager terminal 2, and the operator terminals 4 according to the preferred embodiment of the invention.

The server 1 is configured by a controller 11, a communication unit 12, a storage unit 13, an input unit 16, and a display unit 17, all of which are connected to one another through a bus 18. In addition, the storage unit 13 includes at least a statistical data storage unit 14 and a schedule data storage unit 15. The statistical data storage unit 14 stores statistical data, such as call quantity statistical data, information on operators, and the like. The schedule data storage unit 15 stores assumed schedule data, presumptive schedule data, and various data for generating other schedule data. The various data for generating other schedule data include, for example, estimated call quantity data, weekly holiday data, and the like.

The controller 11 is an information processor (CPU) to perform the calculation and processing of information, and carry out overall control of the server 1. The controller 11 cooperates with the above-mentioned hardware to achieve various functions according to the present invention by reading in and executing various programs stored in the storage unit 13 as necessary.

The storage unit 13 may include a local memory which is used in combination with the controller 11 to execute the programs, a bulk memory of a large capacity, and a cache memory used for efficient data retrieval from the bulk memory. The storage 13 stores various programs executed by the controller 11. Examples of computer readable media for realizing the storage unit 13 may include those realizable electrically, magnetically, optically or electromagnetically. More specifically, examples thereof include a semiconductor memory device, a magnetic tape, a magnetic disk, a random access memory (RAM), a read only memory (ROM), and an optical disk containing a CD-ROM and a CD-R/W and a DVD. Alternatively, the statistical data storage unit 14 and the schedule data storage unit 15 included in the storage unit 13 may be separated from the server 1.

The input unit 16 accepts inputs from a manager and the like, and may include a keyboard, a pointing device, and the like. The input unit 16 can be connected directly or through an interposed I/O controller to the server 1.

The display unit 17 displays a screen accepting data input and a screen showing calculation processing results obtained by the server 1, for the manager and the like. Examples thereof include display apparatuses such as a cathode ray tube (CRT), a liquid crystal display (LCD), and the like.

The communication unit 12 is a network adaptor permitting a connection of the server 1 through the internal communication network 3 or the external communication network 5 to the operator terminals 4 or the operator-portable terminals 6a and 6b, and memories. The communication unit 12 may include a modem, a cable modem, and an Ethernet (registered trademark) adaptor.

The manager terminal 2 and the operator terminals 4 are each configured by controllers 21 and 41, communication units 22 and 42, storage units 23 and 43, input units 24 and 44, and display units 25 and 45, and are connected to one another through buses 26 and 46, respectively.

The controllers 21 and 41 are information processors (CPUs) performing calculation and processing of information, and carry out overall control of the manager terminal 2 and the operator terminals 4, respectively. The controllers 21 and 41 each cooperate with the above-mentioned hardware in achieving various functions of the present invention by appropriately reading in and executing various programs stored in the storage units 23 and 43, respectively.

The storage units 23 and 43 each may include a local memory which is used in combination with the controllers 21 and 41, respectively, in executing the programs, a bulk memory of a large capacity, and a cache memory used for efficient data retrieval from the bulk memory. In addition, the storage units 23 and 43 store various programs to be executed by the controllers 21 and 41, respectively. Examples of computer readable media for realizing the storage units 23 and 43 may include those realizable electrically, magnetically, optically, or electromagnetically. More specifically, examples thereof include a semiconductor memory device, a magnetic tape, a magnetic disk, a random access memory (RAM), a read only memory (ROM), and an optical disk containing a CD-ROM and a CD-R/W and a DVD.

The input units 24 and 44 accept inputs from a manager and the like, and may include a keyboard, a pointing device, and the like. The input units 24 and 44 can each be connected directly or through an interposed I/O controller to the manager terminal 2 and the operator terminal 4, respectively.

The display units 25 and 45 each display a screen accepting data input for user and a screen showing calculation processing results obtained by the manager terminal 2. Examples thereof include display apparatuses such as a cathode ray tube (CRT), a liquid crystal display (LCD), and the like.

The communication units 22 and 42 are each network adaptors permitting the connection of the manager terminal 2 or the operator terminals 4 through the internal communication network 3 or the external communication network 5 to other calculation processing systems or memories. The communication units 22 and 42 may include a modem, a cable modem, and an Ethernet (registered trademark) adaptor.

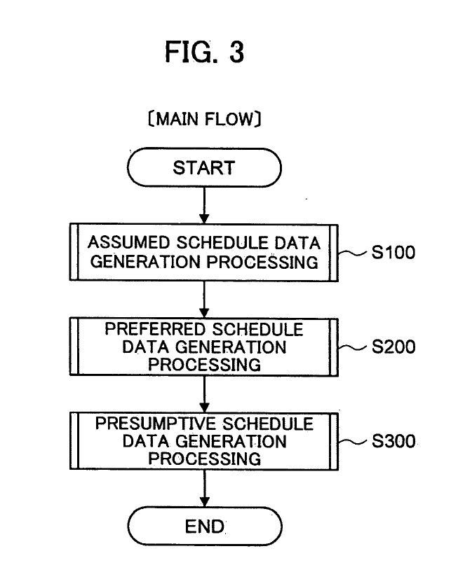

FIG. 3 is a main flow performing schedule generation according to a preferred embodiment of the invention. Description will be made below with reference to the drawings.

In step S100, assumed schedule data generation processing is performed. In this process, the server 1, which has received, for example, an assumed schedule generation request from the manager terminal 2, calculates estimated call quantity data from call quantity statistical data, and based on the estimated call quantity data, generates weekly holiday data containing an assumed necessary number of operators to be referred to by the operators. The details of this process will be described later. Upon termination of this process, the procedure moves to step S200.

In step S200, preferred schedule data generation processing is performed. In this process, for example, the server 1 transmits the assumed schedule data generated in step S100 in response to a request from an operator terminal 4, and generates preferred schedule data adjusted with the operator's desired weekly holiday information and the like transmitted from the operator terminal 4. The details of this process will be described later. Upon termination of this process, the procedure moves to step S300.

In step S300, presumptive schedule data generation processing is performed. In this process, for example, the server 1 generates, in response to a request from the manager terminal 2, presumptive schedule data based on the assumed schedule data generated in step S100 and the preferred schedule data generated in step S200. The details of this process will be described later. Upon termination of this process, the main flow is terminated.

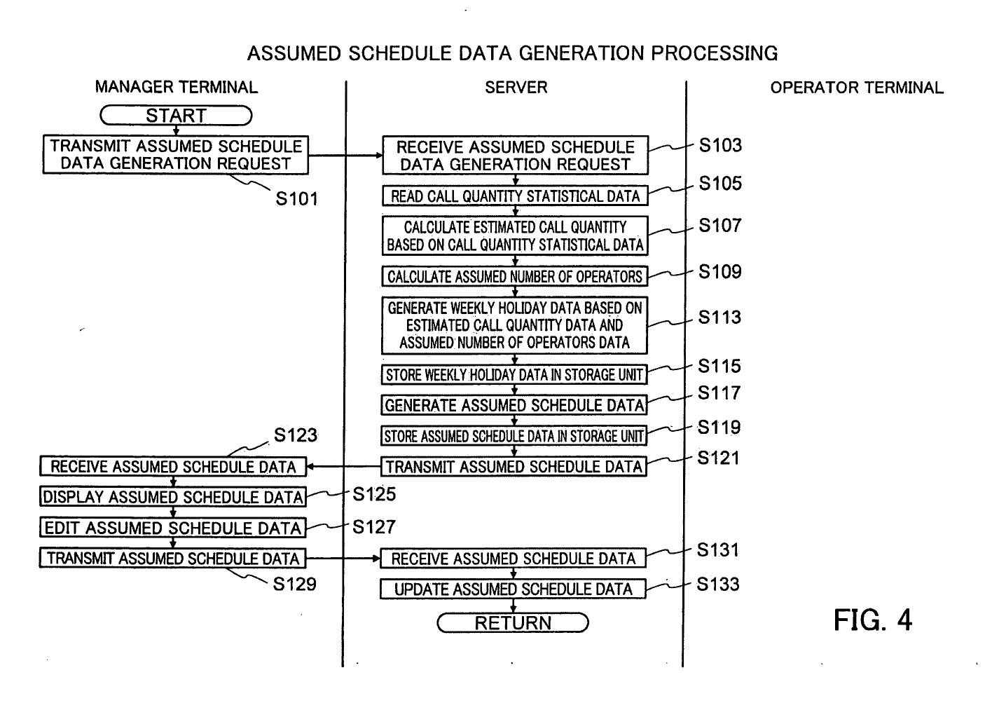

FIG. 4 is a diagram showing the flow of a subroutine to perform assumed schedule data generation processing related to an example of a preferred embodiment of the invention. The assumed schedule data generation processing will be described below with reference to FIGS. 4 to 12.

Firstly, in the manager terminal 2, in response to the manager's input operation, the controller 21 of the manager terminal 2 transmits an assumed schedule data generation request signal through the communication unit 22 to the server 1 (step S101). The controller 11 of the server 1 receives the assumed schedule data generation request signal through the communication unit 12 (step S103).

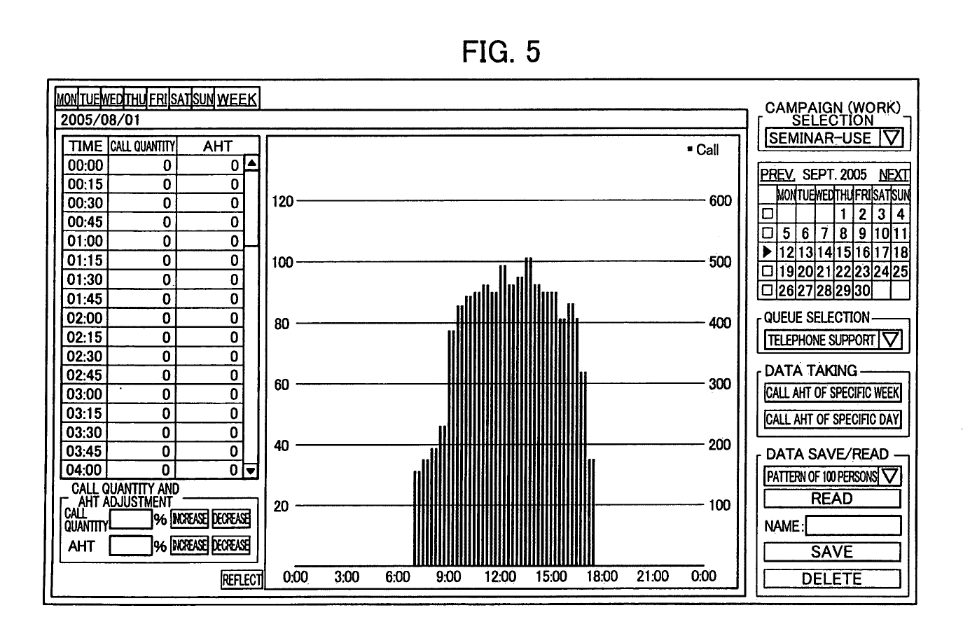

In step S105, the controller 11 of the server 1 reads in call quantity statistical data from the statistical data storage unit 14 in response to receipt of the assumed schedule data generation request signal. The call quantity statistical data are those indicating, for example, a record of the call quantity on a certain day in the past per time zone. The call quantity statistical data can be displayed in a graph such as shown in FIG. 5. The call quantity statistical data to be read in by the server 1 may be specified by a manager when transmitting the assumed schedule data generation request in step S101. Alternatively, the server 1 may automatically select and read in the call quantity statistical data on the date of the nearest preceding day or the past same week day. Upon termination of this process, the procedure moves to step S107.

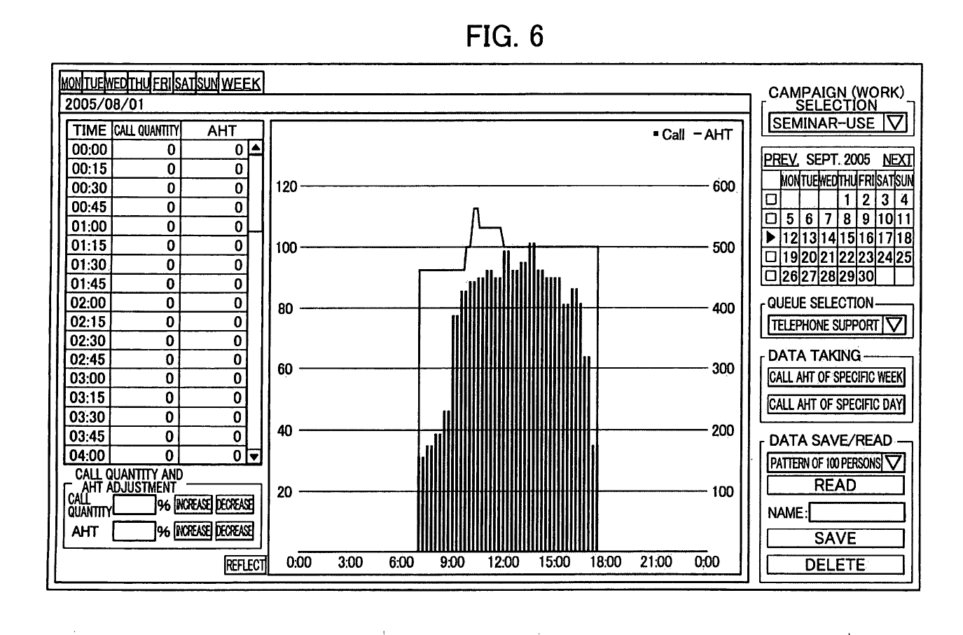

In step S107, the controller 11 calculates an estimated call quantity based on the call quantity statistical data. The calculation of the estimated call quantity is performed by calculating an average per week or an average on a specific day, based on, for example, the call quantity statistical data read in in step S105. At the time of this processing, the controller 11 may firstly transmit call quantity statistical data to the manager terminal 2 so as to be displayed on the manager terminal 2 (FIG. 6). After accepting an adjustment input of a manager, the controller 21 of the manager terminal 2 may transmit the adjusted estimated call quantity data to the server 1. Alternatively, the server 1 may be preset to perform the calculation from, for example, a weekly average, and the controller 11 of the server 1 may automatically read in the call quantity statistical data and calculate an estimated call quantity. Upon termination of this process, the procedure moves to step S109.

In step S109, the controller 11 calculates an assumed necessary number of operators based on the estimated call quantity. Specifically, the necessary number of operators is calculated from, for example, predetermined target processing time and estimated call quantity, an average wait time, and the like.

For example, consider a case where the number of operators is seven and the time necessary for an operator to handle a call is five minutes. When 66 calls occur at random for one hour, the number of operators is calculated so that the average wait time is not more than 12 seconds. To obtain an incoming total call quantity a, since there are 66 calls in 1 hour and the speaking time h is 5 minutes:

$$a = \frac{66}{60} \cdot 5 = 5.5 \qquad ( Equation 1 )$$

Calculation is made by substituting 7 for the number of operators c into the following equation.

$${E}_{c} ( a ) = \frac{{aE}_{c - 1} ( a )}{c + {aE}_{c - 1} ( a )} \\ {E}_{0} ( a ) = 1 \qquad ( Equation 2 )$$

From Equation 2, E7(5.5)=0.15

Then, the average wait time W is obtained from this by the following equation.

$$W = \frac{h}{c - a} \cdot \frac{{cE}_{c} ( a )}{c - a + {aE}_{c} ( a )} = 1.52 minutes \qquad ( Equation 3 )$$

This shows that the current average waiting time is 1.52 minutes. Subsequently, Equation 3 is used to calculate the number of operators c so as to achieve an average waiting time W of 12 seconds or less. When c=9, W=0.185 minutes (11.1 seconds), so in this case, the calculation result indicates that 9 operators are required.

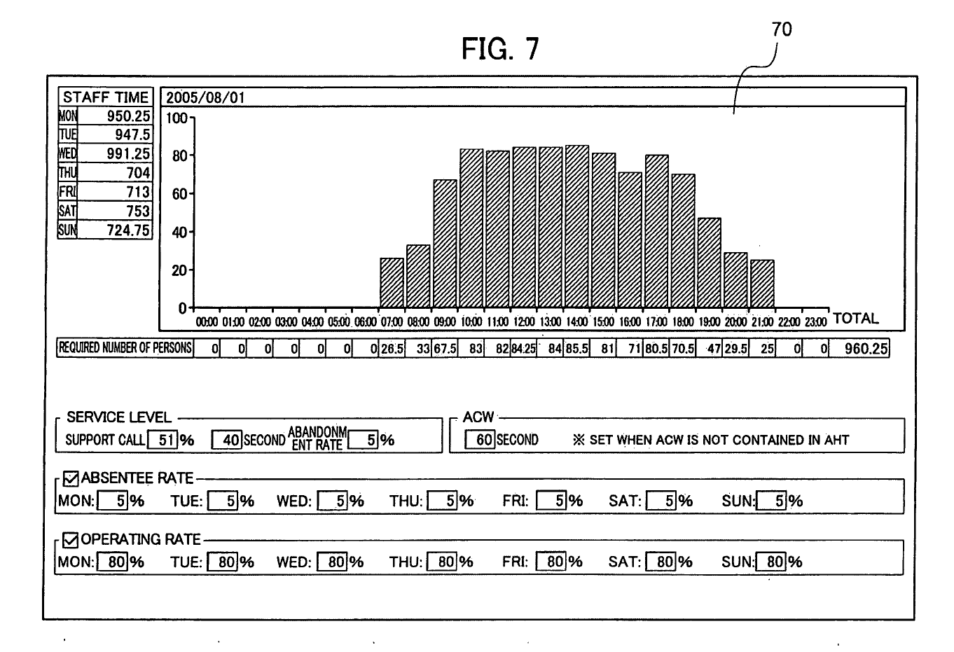

The assumed necessary number of operators may be calculated by taking into consideration other items. Examples thereof include an abandonment rate indicating a rate of failed call answering and an absenteeism rate of operators, service level, and the like. The service level indicates how many seconds are needed to answer what percentage of calls of incoming answer calls. For example, as shown in FIG. 7, the calculation results of assumed necessary numbers of operators per unit time may be displayed on a display unit 25 of the manager terminal 2. In this FIG. 7, a bar graph 70 indicates an assumed necessary number of operators per unit time. Upon termination of this process, the procedure moves to step S13.

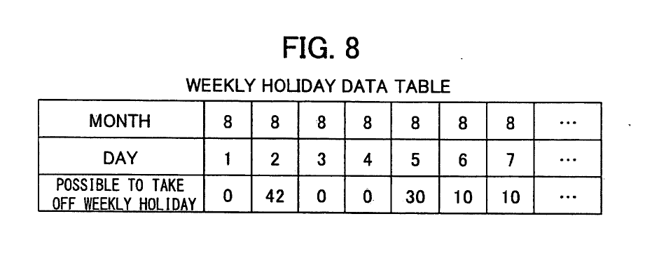

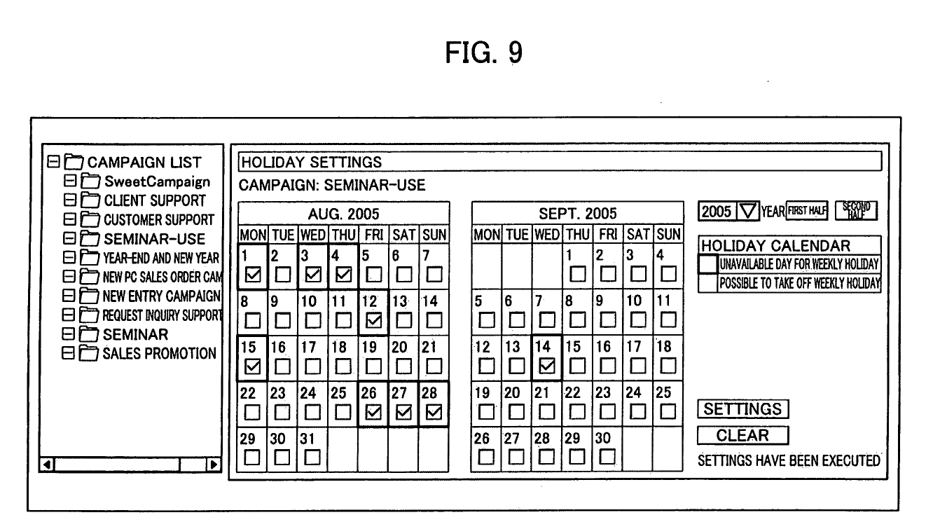

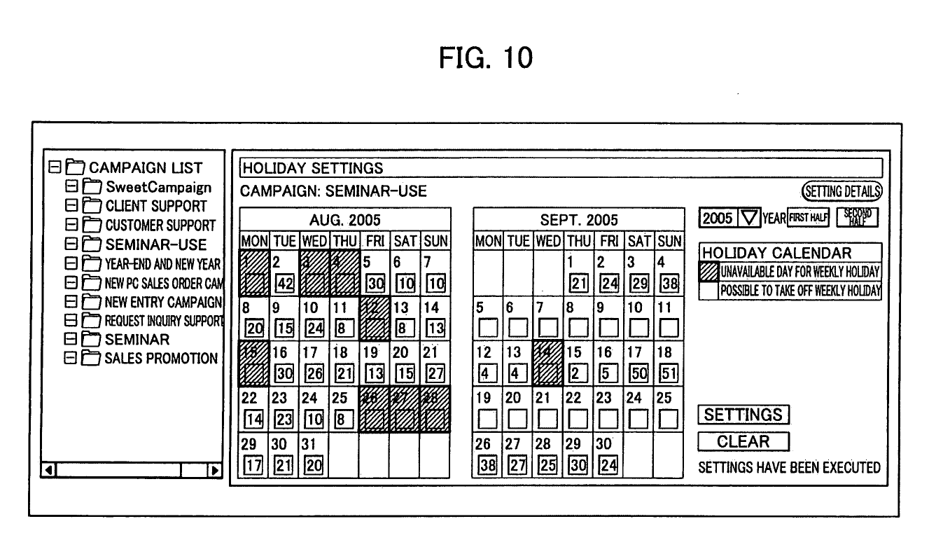

In step S113, the controller 11 generates weekly holiday data based on estimated call quantity data and data of an assumed necessary number of operators. Specifically, for example, the controller 11 automatically calculates a number of operators who can take off a weekly holiday with respect to the current total number of operators, based on the estimated call quantity data and the assumed necessary number of operators. For example, similarly to as in a weekly holiday table shown in FIG. 8, a number of operators who can take off a weekly holiday is inputted for a certain day. In this weekly holiday data table, a case where the number of operators who can take off a weekly holiday is zero corresponds to an unavailable day for a weekly holiday. Alternatively, the unavailable day for a weekly holiday may be transmitted to the manager terminal 2 in response to the receipt of a request signal from the manager terminal 2, and displayed by the controller 21 of the manager terminal 2 on a display unit 17 such as shown in FIG. 9, and set through which the manager may input an arbitrary day as an unavailable day for a weekly holiday. FIG. 9 indicates that an unavailable day for a weekly holiday can be set by entering a check in the check box for each day. Alternatively, data of a number of operators who can take off a weekly holiday may be transmitted to the manager terminal 2 in response to a receipt of a request signal from the manager terminal 2, and the controller 21 of the manager terminal 2 may display the data on the display unit 17, as shown in FIG. 10. Upon termination of this process, the procedure moves to step S115.

In step S115, the controller 11 stores peak data and weekly holiday data in the schedule data storage unit 15 of the storage unit 13. Upon termination of this process, the procedure moves to step S117.

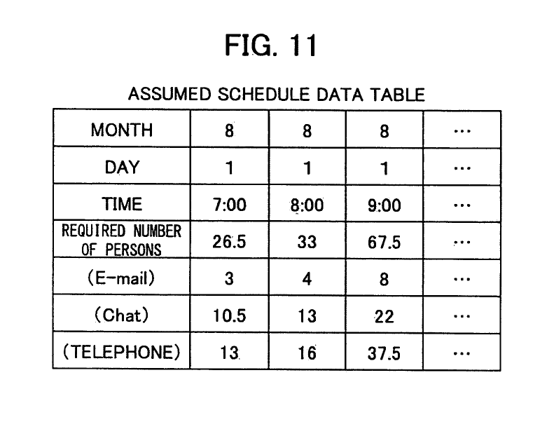

In step S117, the controller 11 generates assumed schedule data. The assumed schedule data are represented by, for example, such a table as shown in FIG. 11. The assumed schedule data table of FIG. 11 is a table indicating an assumed necessary number of operators per time zone on a certain day. FIG. 11 shows that, for example, the assumed necessary number of operators is 26 at seven o'clock on the first day in August. Upon termination of this process, the procedure moves to step S119.

In step S119, the controller 11 stores assumed schedule data in the schedule data storage unit 15 of the storage unit 13, and transmits the assumed schedule data to the manager terminal 2 (step S121). Upon termination of this process, the procedure moves to step S123.

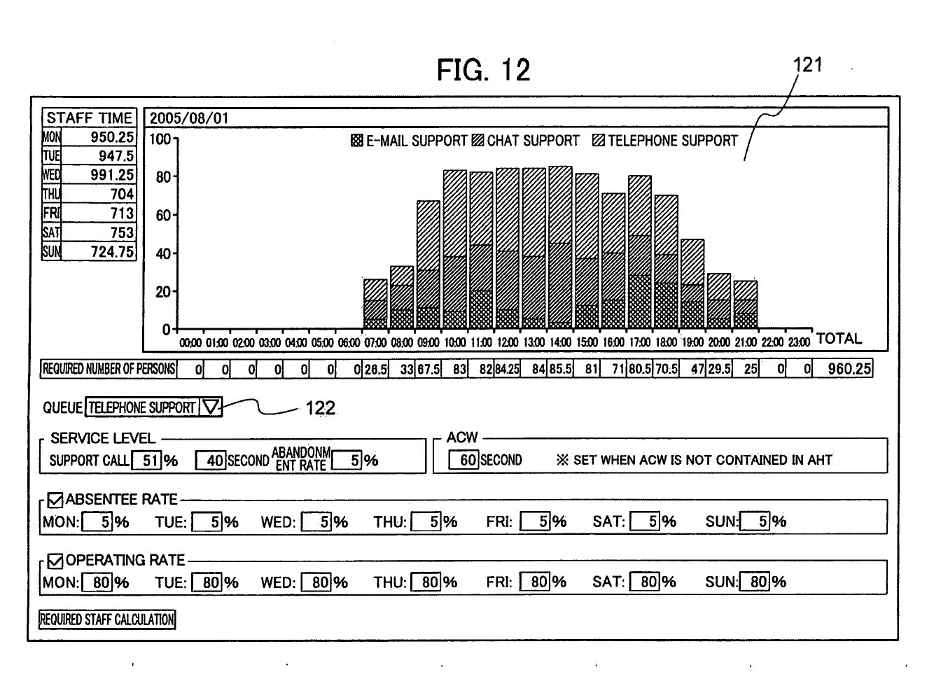

In step S123, the controller 21 of the manager terminal 2 receives the assumed schedule data and displays the assumed schedule data on a display unit 25 (step S125). Specifically, for example, a screen similar to that shown in FIG. 12 is displayed. In FIG. 12, an assumed necessary number of operators per unit time and work type are displayed. For example, a graph 121 in FIG. 12 shows respective numbers of necessary operators for three types of work: “e-mail support,” “chat support” and “telephone support.” In addition, by selecting a task name whose necessary number of operators is desired to be calculated from a queue menu 122, a screen per task can be displayed, and a necessary number of persons for each task can be calculated. For example, the display example of FIG. 12 indicates a screen calculating a necessary number of persons for the telephone support task. Thus, not only necessary number of operators for all tasks, but also necessary number of operators per task, can be displayed, making it possible to set an assumed schedule for recruiting skilled operators for each task.

Here, a manager can edit the assumed schedule data as needed. For example, while displaying the screen as shown in FIG. 12 on the display unit 25, an increase/decrease of estimated call quantity, capacity operating rate, and time required to answer may be inputted to perform editing such as an estimated increase/decrease of a number of assumed necessary number of operators (step S127).

In step S129, the controller 21 of the manager terminal 2 transmits the edited assumed schedule data through the communication unit 22 to the server 1. In step S131, the controller 11 of the server 1 receives the assumed schedule data transmitted from the manager terminal 2 through the communication unit 12, and updates the assumed schedule data (step S133). Upon termination of this process, the present subroutine is completed, and the procedure moves to step S200 in FIG. 3.

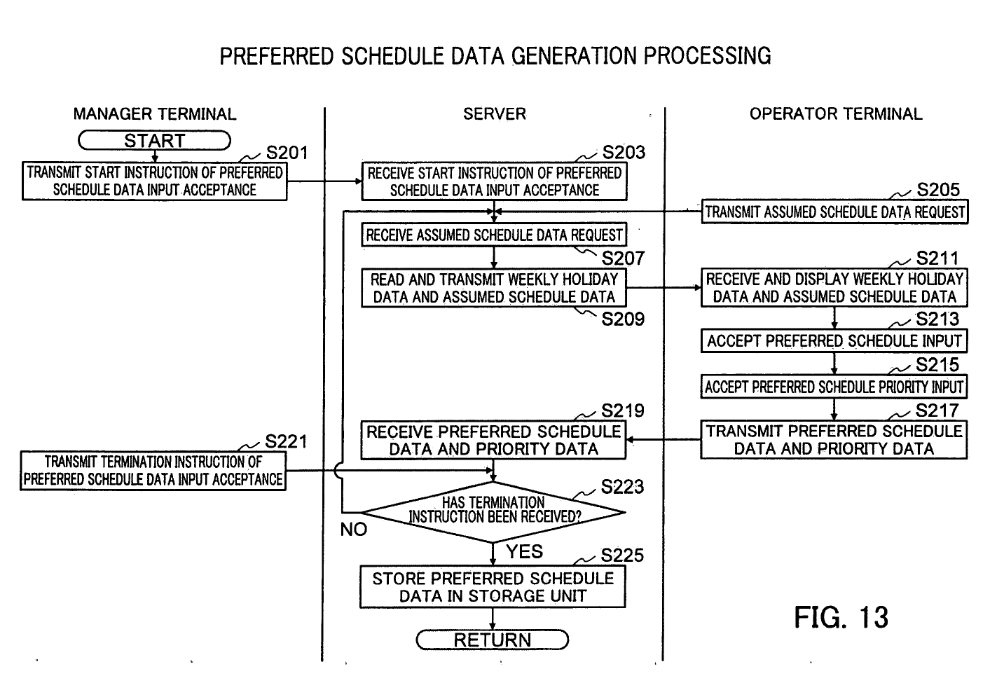

FIG. 13 is a flowchart showing a subroutine performing preferred schedule data generation processing in an example of a preferred embodiment of the invention. The preferred schedule data generation process is described below with reference to FIGS. 13 to 15.

Firstly, in step S201, the controller 21 of the manager terminal 2 transmits a start instruction signal of preferred schedule data input acceptance through the communication unit 22 to the server 1. In addition, the controller 11 of the server 1 receives the start instruction signal of preferred schedule data input acceptance through the communication unit 12, and starts the acceptance from the operator terminals 4 (step S203).

In step S205, a controller 41 of the operator terminal 4 transmits an assumed schedule data transmission request signal through a communication unit 42. The controller 11 of the server 1 receives the assumed schedule data transmission request signal through the communication unit 12 (step S207), and then reads in the assumed schedule data and the weekly holiday data from the schedule data storage unit 15, and transmits these data to the operator terminals 4 through the communication unit 12 (Step S209).

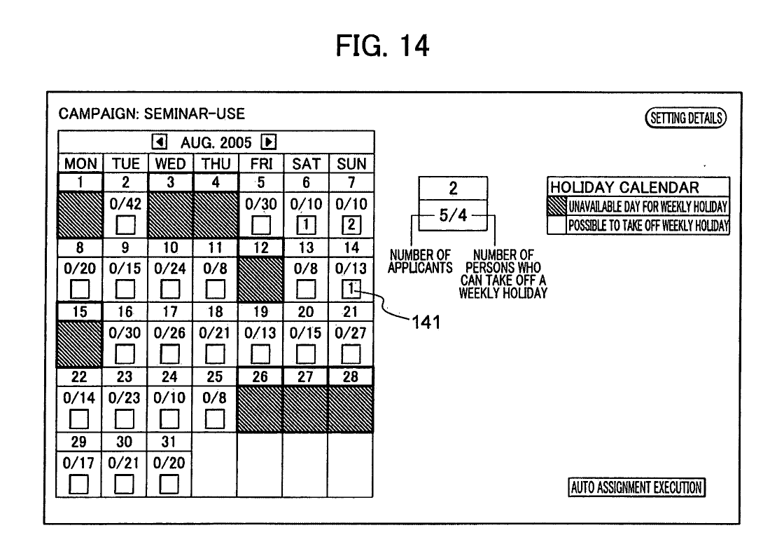

In step S211, the controller 41 of the operator terminal 4, which has received the assumed schedule data and the weekly holiday data from the server 1, displays these data on a display unit 45. In addition, while viewing these data, the operator then takes into consideration the preferred schedule data while inputting through the input unit 44. Specifically, the consideration is made on, for example, the screen to set desired weekly holidays as shown in FIG. 14. In FIG. 14, a number of operators who can take off a weekly holiday, and a current number of applicants, are indicated per day. Referring to this, an operator inputs checks or a priority (described later) into input boxes 141. In addition, a screen to be displayed on the display unit 45 may be updated at least whenever other operators transmit weekly holiday data to the server 1 and the server 1 receives the weekly holiday data. The operation in which an operator refers to the screen, as shown in FIG. 14, produces an effect of urging an operator who is going to input desired weekly holidays to apply for desired weekly holidays other than for either days for which the number of applicants is already over the number of operators who can take off a weekly holiday, or days for which the former is equal to the latter. Thus, an operator can confirm, on a display of the display unit 45 of the operator terminal 4, information in which other operators' preferred schedule data transmissions are reflected, at any time. Further, weekly holiday data to be transmitted is changed continually, and therefore, operators can always adjust their own preferences based on the latest information. Therefore, this minimizes a necessity that a manager must readjust weekly holiday data when a number of applicants exceeds the number of operators who can take off a weekly holiday, thus enabling cooperative labor-management relationship to be naturally fostered, while reducing the burden of the manager.

In step S215, the controller 41 of the operator terminal 4 accepts an input of a priority of desired weekly holidays. Alternatively, this input operation may be performed by applying for a weekly holiday with associated priority through the screen shown in FIG. 14. Specifically, the controller 41 accepts inputs of priority numbers to the input boxes 141 for applications for a weekly holiday. For example, when the priority is the first, a “1” is inputted to the input box 141, and when the priority is the second, a “2” is inputted to the input box 141. Input of the priority is then transmitted to the server 1 as priority data. When no priority is set, a check may be inputted to the input boxes 141. Upon termination of this process, the procedure moves to step S217.

In step S217, the controller 41 of the operator terminal 4 generates preferred schedule data based on inputs accepted so far in steps S213 and S215, and transmits the generated data together with the priority data to the server 1 through the communication unit 42. Note that any number of transmissions can be performed until the server 1 receives a termination instruction signal of preferred schedule data input acceptance (the details thereof will be described later) from the manager terminal 2. This number of transmissions may be a predetermined number per operator, or it may be unlimited. Upon termination of this process, the procedure moves to step S219. Here, an allowable number of transmissions of preferred schedule data and an allowable number of transmissions of each the corresponding priority may be adjustable per operator by accepting an input of a manager. In this case, the manager will adjust these parameters in consideration of past evaluations and task performances of each operator.

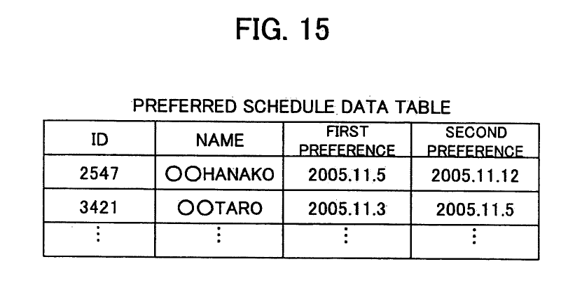

In step S219, the controller 11 of the server 1 receives preferred schedule data and priority data transmitted from the operator terminal 4. Then, the controller 11 registers the preferred schedule data transmitted from the individual operator terminals 4 in a preferred schedule data table. For example, a preferred schedule data table as shown in FIG. 15 is generated. In this table, the operator ID, the operator name and the first and second preferences for weekly holidays are registered. The priority of preferences for weekly holidays is not limited to the first and second preferences as indicated in FIG. 15. The priority may be extended to a third preference, a fifth preference or additional preferences may be added, or only the first preference may be employed. Alternatively, a plurality of first preferences may be accepted.

Acceptances of the preferred schedule data and the priority data continue until a termination instruction signal of preferred schedule data input acceptance from the manager terminal 2 is transmitted to the server 1 (step S221). The termination instruction signal of preferred schedule data input acceptance may be transmitted by the following steps in the manager terminal 2 in which the manager inputs a transmission instruction through the input unit 24, and the controller 21 accepts the instruction. Alternatively, a predetermined period of time may be preset, and the preferred schedule data input acceptance may be terminated automatically after the elapse of the predetermined period of time.

In step S223, the controller 11 determines whether it received or not the termination instruction signal of preferred schedule data input acceptance from the manager terminal 2. If the termination instruction signal of preferred schedule data input acceptance has not been received, the procedures returns to step S205 or step S207, and acceptances of the assumed schedule data request or the preferred schedule data and the priority data from the operator terminals 4 are continued. Upon receipt of the termination instruction signal of preferred schedule data input acceptance, the preferred schedule data table registered so far is stored in the schedule data storage unit 15 (step S225). Upon termination of this process, the present subroutine is completed, and procedure moves to step S300 in FIG. 3.

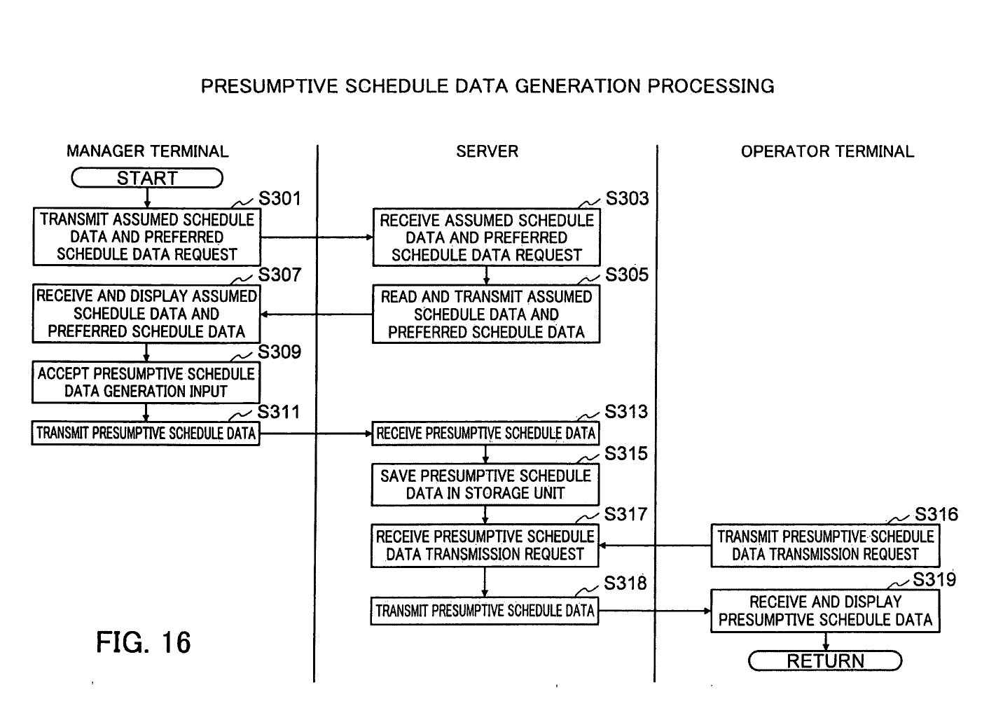

FIG. 16 is a diagram showing a subroutine to perform presumptive schedule data generation processing in an example of a preferred embodiment of the invention. The presumptive schedule data generation processing will be described below with reference to FIGS. 16 to 20.

Firstly, in order to set a presumptive schedule, the controller 21 of the manager terminal 2 transmits the transmission request signals of the assumed schedule data and the preferred schedule data to the server 1 through the communication unit 22 (step S301).

In step S303, the controller 11 of the server 1 receives through the communication unit 12 the transmission request signals of the assumed schedule data and the preferred schedule data. The controller 11 then reads in the assumed schedule data and the preferred schedule data from the schedule data storage unit 15, and transmits these data through the communication unit 12 to the manager terminal 2 (step S305).

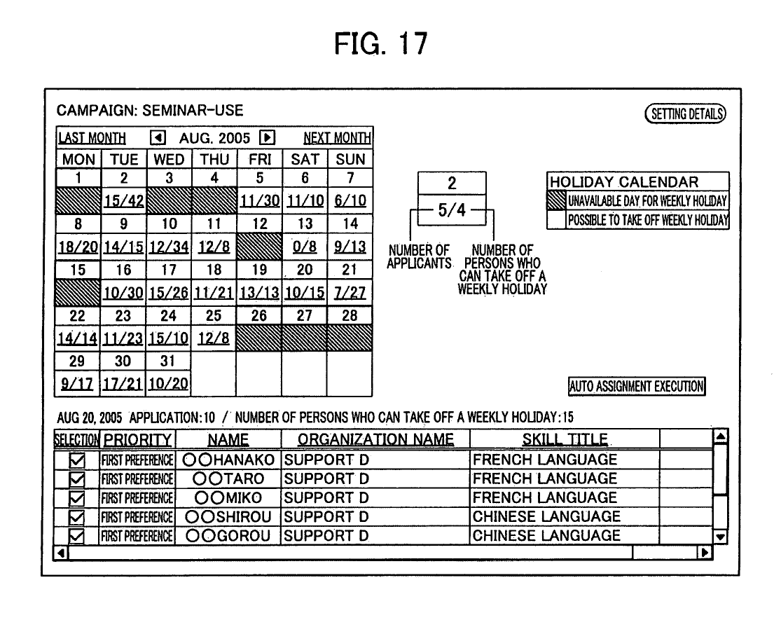

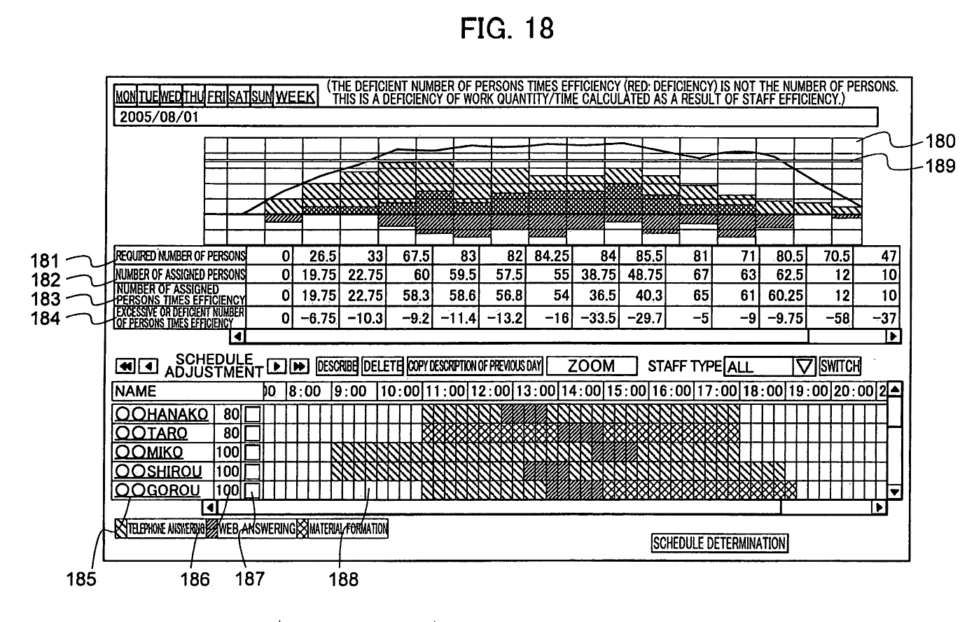

In step S307, the controller 21 of the manager terminal 2 receives the assumed schedule data and the preferred schedule data transmitted from the server 1, and displays these data on the display unit 25. For example, the screen as shown in FIG. 17 or 18 is displayed as a presumptive schedule generation screen.

FIG. 17 shows a screen displaying operators applying for a weekly holiday along with a number of operators who can take a weekly holiday and current applicant numbers. A manager allows weekly holidays while viewing this screen. This screen indicates a name and the like of the operators applying for a weekly holiday, together with the number of operators who can take a weekly holiday and the current number of applicants, based on information of the preferred schedule data table received in step S307. Permission to take a weekly holiday is set by accepting a manager's input operation to selection check boxes (step S309).

FIG. 18 indicates a graph 180, an assumed necessary number of operators 181, a number of available operators assigned to a necessary number of operators 182, a number of assigned persons times efficiency 183, which is obtained by multiplying the number of assigned persons by efficiency, and an excessive or deficient number of persons times efficiency 184. The number of assigned persons times efficiency 183, and the excessive or deficient number of persons times efficiency 184 are the values of task quantity/time calculated based on an operator processing efficiency 186. A time zone in which an assumed necessary number of operators is not reached is represented by a minus symbol in the column of the excessive or deficient number of persons times efficiency 184. This indicates a lack of operators. Simultaneously, this is also represented by a minus symbol on a bar graph 188.

The underlying table 185 indicates available operators and the each operator's task processing efficiencies 186, and a manager determines and inputs which operator is actually employed. An input operation is carried out by, for example, inputting a check mark into check boxes 187 of a line describing an operator whom a manager wishes to employ (step S309). Whenever the manager inputs a check mark into the check box 187, then the graph 180, the number of assigned persons 182, the number of assigned persons times efficiency 183, and the excessive or deficient number of persons times efficiency 184 may be changed. The manager continues to assign operators until the number of assigned persons times efficiency satisfies the necessary number of persons. For example, assuming an average operator processing efficiency is 100, when there is a task requiring a processing of 300, it is necessary to employ three operators having a processing efficiency of 100. On the other hand, two operators having a processing efficiency of 150 can handle this task. On the other hand, if there are two new operators who are unfamiliar with a task and hence have a processing efficiency of 50, it is necessary to employ two operators having a processing efficiency of 100, in addition to those two operators having a processing efficiency of 50. This results in a total of four operators. Thus, consideration of the operators' processing efficiencies enables scheduling of a necessary number of operators satisfying a necessary task quantity. This achieves an assignment of a necessary number of operators, causing neither excess nor deficiency in task quantity, unlike a case of scheduling only by the necessary number of operators.

A bar graph 188 indicates already-set individual operators' schedules. In the bar graph 188, the types of tasks may be color coded so that it is possible to confirm how many operators are currently assigned to these types of tasks, respectively. This enables flexible schedule management. For example, operators, to which a task of forming materials (data) or web answering, having low urgency are assigned, can be assigned as staff members who can also answer calls when there are a large number of calls.

Thus, the manager generates a presumptive schedule by using these screens. Upon termination of this process, the procedure moves to step S311. The upper limit of staff members employed may be a maximum number capable of working concurrently, such as a number of available seats, and the like. An upper limit of staff members is indicated by the upper limit line 189 in the graph 180. Thus, it is possible to set settings so that a number of operators exceeding a maximum number indicated by the upper limit line 189 in the graph 180 cannot be employed on the table 185. At a time of inputting a check mark exceeding a maximum number into the check box 187, the controller 11 of the server 1 may transmit a message describing an invalid input to the manager terminal 2, and the controller 21 of the manager terminal 2 may display the received message on the display unit 25. Alternatively, the controller 11 of the server 1 may not accept the above check input. A case of assuming a necessary number of persons exceeding the upper limit line 189 indicates that a maximum number of operators who can work concurrently is insufficient for a task.

This helps a manager to judge whether, for example, a current number of available seats is suitable for the task. For example, a case where a necessary number of persons is far above the upper limit line 189 indicates a necessity of increasing the number of seats. A case where a necessary number of persons is always below the upper limit line 189 indicates that the number of seats is too high.

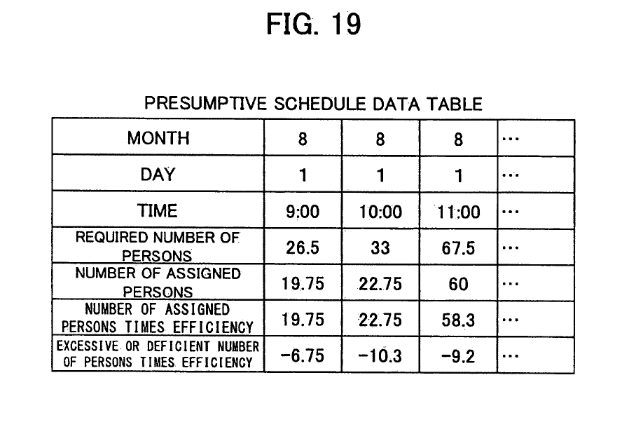

In step S311, the controller 21 of the manager terminal 2 transmits presumptive schedule data generated in step S309 to the server 1 through the communication unit 22. The transmitted presumptive schedule data can be, for example, a table as shown in FIG. 19. The presumptive schedule data table indicates a necessary number of persons, a number of assigned persons, a number of assigned persons times efficiency, and an excessive or deficient number of persons times efficiency, in certain time zones on a certain day. For example, in FIG. 19, in the time zone from nine o'clock to ten o'clock on the first day in August, the necessary number of persons is 26.5, the current number of assigned persons is 19.75, the number of assigned persons times efficiency is 19.95, and the excessive or deficient number of persons times efficiency is minus 6.75. Thus, the above presumptive schedule data have the information of a presumptive assigned number of staff members (operators) and an excessive or deficient number of persons with respect to a necessary number of persons, which is obtained by subtracting a necessary number of persons from a number of assigned persons. The above data also indicate a current number of operators and an excessive or deficient number of operators per day and/or time zone. Although in FIG. 19, the table is formed of time units, namely of hours, other time units may also be used. For example, a time unit may be a short time unit such as ten minutes, or alternatively a long time unit, such as two hours. When a maximum number of operators is set and a necessary number of persons exceeds a maximum number of operators, a value of excessive or deficient number of persons times efficiency is the value obtained by subtracting the maximum number of operators from the number of assigned persons times efficiency. The reason is that it is actually impossible to assign operators exceeding the maximum number thereof. It is thus possible to indicate a number of assignable persons times efficiency, which is substantially insufficient.

In step S313, the controller 11 of the server 1 receives presumptive schedule data through the communication unit 12. The controller 11 then stores the received presumptive schedule data in the schedule data storage unit 15 (step S315).

In response to a transmission request from the operator terminal 4 (step S316), the controller 11 of the server 1, which has received the transmission request (step S317), transmits the presumptive schedule data through the communication unit 12 to the operator terminal 4 (step S318). This transmission may be automatically performed through a mail server to the operator-portable terminals 6a and 6b.

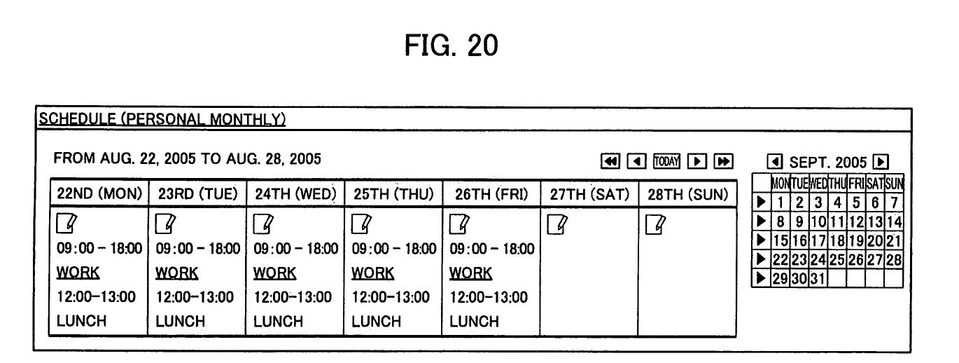

In step S319, the controller 41 of the operator terminal 4 receives through the communication unit 42 the presumptive schedule data transmitted from the server 1, and displays the data on the display unit 45. Simultaneously, the data may be stored in the storage unit 43. The presumptive schedule data displayed on the display unit 45 becomes, for example, a screen as shown in FIG. 20. The screen is a table indicating work time and the weekly holiday day for each day. Although FIG. 20 is a weekly display, it may be a monthly display or a daily schedule display. Upon termination of this process, the present subroutine is completed.

While embodiments of the present invention have been described and illustrated above, it is to be understood that these are examples of the invention and are not to be considered limiting. Effects described in the embodiments of the present invention are a mere listing of the most suitable effects produced by the present invention, and the effects produced by the present invention are not limited to those described in the foregoing embodiments.

What is claimed:

1. A method for managing work schedules of a plurality of staff members by a computer connected to a communication network, comprising the steps of:
an assumed schedule data generation step in which the computer generates assumed schedule data indicating assumed schedules of the plurality of staff members;
a preferred schedule data acceptance starting step in which the computer specifies a predetermined period of time and starts to accept preferred schedule data indicating preferred schedules of the plurality of staff members from terminals connected to the communication network;
an assumed schedule data transmission step in which the computer transmits the generated assumed schedule data to the terminals connected to the communication network in response to requests from the terminals, respectively;
a preferred schedule data receiving step in which the computer receives from the terminals the preferred schedule data indicating preferred schedules of the plurality of staff members, respectively, and stores the preferred schedule data; and
a presumptive schedule data generation step in which, after an elapse of the specified predetermined period of time, the computer generates presumptive schedule data indicating presumptive schedules of the plurality of staff members based on the assumed schedule data and the preferred schedule data.

2. The method according to claim 1, wherein the computer transmits the stored preferred schedule data to the terminals in response to requests from the terminals, respectively, in the assumed schedule data transmission step.

3. The method according to claim 1, wherein the computer further generates peak data indicating peak information related to the assumed schedule in the assumed schedule data generation step; and
the computer additionally transmits the generated peak data to the terminals in the assumed schedule data transmission step.

4. The method according to claim 1, wherein the computer additionally receives priority data indicating the priority of the preferred schedule in the preferred schedule data receiving step; and
the computer generates presumptive schedule data based on the assumed schedule data, the preferred schedule data and the priority data in the presumptive schedule data generation step.

5. The method according to claim 1, wherein the computer receives the preferred schedule data a predetermined number of times from individual staff members' terminals, respectively, in the preferred schedule data receiving step.

6. The method according to claim 1, wherein the computer generates the presumptive schedule data limited to a range where the number of the plurality of staff members does not exceed a prespecified maximum number, in the presumptive schedule data generation step.

7. The method according to claim 1, wherein the computer generates the presumptive schedule data based on processing efficiency data of the plurality of staff members with respect to a predetermined task, in the presumptive schedule data generation step.

8. The method according to claim 1, wherein the computer generates a plurality of overlapped presumptive schedules of a predetermined staff member among the plurality of staff members, in the presumptive schedule data generation step.

9. A program causing a computer connected to a communication network to manage work schedules of a plurality of staff members, the program causing the computer to perform the steps of:
an assumed schedule data generation step causing the computer to generate assumed schedule data indicating assumed schedules of the plurality of staff members;
a preferred schedule data acceptance starting step causing the computer to specify a predetermined period of time and start to accept preferred schedule data indicating preferred schedules of the plurality of staff members from terminals connected to the communication network;
an assumed schedule data transmission step causing the computer to transmit the generated assumed schedule data to terminals connected to the communication network in response to requests from the terminals, respectively;
a preferred schedule data receiving step causing the computer to receive from the terminals the preferred schedule data indicating preferred schedules of the plurality of staff members, respectively, and to store the preferred schedule data; and
a presumptive schedule data generation step causing, after an elapse of the specified predetermined period of time, the computer to generate presumptive schedule data indicating presumptive schedules of the plurality of staff members based on the assumed schedule data and the preferred schedule data.

10. The program according to claim 9, further comprising:
causing the computer to transmit the stored preferred schedule data additionally to the terminals in response to requests from the terminals, respectively, in the assumed schedule data transmission step.

11. The program according to claim 9, further comprising:
causing the computer further to generate peak data indicating peak information related to the assumed schedule in the assumed schedule data generation step; and
causing the computer additionally to transmit the generated peak data to the terminals in the assumed schedule data transmission step.

12. The program according to claim 9, further comprising:
causing the computer to additionally receive priority data indicating the priority of the preferred schedule in the preferred schedule data receiving step; and
causing the computer to generate presumptive schedule data based on the assumed schedule data, the preferred schedule data, and the priority data in the presumptive schedule data generation step.

13. The program according to claim 9, further comprising:
causing the computer to receive the preferred schedule data a predetermined number of times from the individual staff members' terminals, respectively, in the preferred schedule data receiving step.

14. The program according to claim 9, further comprising:
causing the computer to generate the presumptive schedule data limited to a range where the number of the plurality of staff members does not exceed a prespecified maximum number, in the presumptive schedule data generation step.

15. The program according to claim 9, further comprising:
causing the computer to generate the presumptive schedule data based on processing efficiency data of the plurality of staff members with respect to a predetermined task, in the presumptive schedule data generation step.

16. The program according to claim 9, further comprising:
causing the computer to generate a plurality of overlapped presumptive schedules of a predetermined staff member among the plurality of staff members, in the presumptive schedule data generation step.

17. A storage medium storing the program according to claim 9.
